(19) United States
(12) Patent Application Publication
(10) Pub. No.: US 2020/0308887 A1
(43) Pub. Date: Oct. 1, 2020

(54) HOUSEHOLD REFRIGERATION APPARATUS WITH SPECIFIC HEIGHT ADJUSTING DEVICE FOR A DOOR

(71) Applicant: BSH HAUSGERAETE GMBH, MUENCHEN (DE)

(72) Inventors: ALFRED RAAB, HUETTLINGEN (DE); JOHANNES KOEPF, AMSTETTEN (DE); SIMON KRAEMER, AALEN (DE)

(21) Appl. No.: 16/651,010

(22) PCT Filed: Nov. 28, 2018
(86) PCT No.: PCT/IB2018/059382

§ 371 Date: Mar. 26, 2020

(30) Foreign Application Priority Data
Feb. 5, 2018 (CN) 201810111440.2

(51) Int. Cl. E05D 7/04; F25D 23/02; E05D 3/02

(52) U.S. Cl. CPC E05D 7/0415; F25D 23/028; E05Y 2900/31; F25D 2323/024; E05D 2007/0469; E05D 3/02

(57) ABSTRACT

A household refrigeration apparatus has a housing with a door that is pivotally mounted to the housing by a hinge. The hinge has a pivot and a separate base part, at which the pivot is rotatably supported around a rotational axis. A height adjusting device is formed at the hinge for adjusting the door in the height position in height direction relative to the housing. The pivot includes an annular coupling disk of the height adjusting device, which is coupled to a coupling receptacle formed in the base part. An individual height position of the pivot is adjusted depending on the rotational position of the coupling disk around the rotational axis relative to the coupling receptacle. The coupling disk has a coupling element with ramp-like oblique flanks on both sides, by which the coupling element axially plunges into the coupling receptacle in the direction of the rotational axis.

The invention relates to a household refrigeration apparatus with a housing and with a door, which is pivotably disposed at the housing by a hinge. The hinge comprises a pivot and a base part separate thereto, at which the pivot is rotatably supported around a rotational axis. Moreover, the household refrigeration apparatus comprises a height adjusting device, which is formed at the hinge and by which the door is adjustable in the height position in height direction of the household refrigeration apparatus relative to the housing.

In household refrigeration apparatuses, front-side doors are pivotably disposed at the housing by hinges. Due to individual tolerances, the height position of the door relative to the housing and/or relative to a further door of the household refrigeration apparatus can be undesirably misaligned such that clearances or the like are for example also inaccurate in this respect.

Individual height adjustments at doors of household refrigeration apparatuses are generally known.

However, they are often difficultly accessible and difficultly to operate such that a corresponding change of the height position of the door is only possible to a limited extent and is restricted with respect ease of assembly.

It is the object of the present invention to provide a household refrigeration apparatus, in which the adjustment of the height position of a door of the household refrigeration apparatus is allowed in simple manner and accurate in position.

This object is solved by a household refrigeration apparatus, which comprises the features according to claim 1.

One aspect of the invention relates to a household refrigeration apparatus with a housing and with a door separate thereto. The household refrigeration apparatus comprises at least one hinge, by which the door is pivotably disposed at the housing. The hinge comprises a pivot and a base part separate thereto, at which the pivot is rotatably supported around a rotational axis. Furthermore, the household refrigeration apparatus comprises a height adjusting device, which is formed at the hinge and by which the door is adjustable in the height position in height direction of the household refrigeration apparatus relative to the housing. Preferably, the pivot comprises an in particular annular coupling disk, which is a constituent of the height adjusting device. This coupling disk is coupled to a coupling receptacle formed in the base part, which is also a constituent of the height adjusting device. Depending on a rotational position of the coupling disk around the rotational axis relative to the coupling receptacle, an individual height position of the pivot is adjusted. The coupling disk comprises a coupling element, which comprises ramp-like oblique flanks on both sides viewed in circumferential direction around the rotational axis. Upon reaching a defined height position of the pivot, the coupling element is disposed axially plunging into the coupling receptacle with the oblique flanks viewed in the direction of the rotational axis.

By such a specific configuration, an exclusively mechanic height adjusting device is provided, which is able to simply yet accurately adjust the height position of the door. By the individual configuration of the pivot with specific components of the height adjusting device as well as the base part with specific components of the height adjusting device, at the essential members of the hinges themselves, this height adjusting device can virtually in particular also be integrally or one-piece formed therewith. Thereby, a space saving concept is also provided and a highly functional height position adjustment is also achieved. Moreover, especially such a configuration is also mechanically robust, and corresponding loadings can be absorbed. The design of the coupling element with the azimuthal ramp-like shaping is in a particularly advantageous configuration. By such a configuration, simple azimuthal rotation of the coupling element from the coupling receptacle is achieved especially in circumferential direction around the rotational axis upon adjusting the height position in this respect, and corresponding continuous and gentle sliding into the coupling receptacle is then also again allowed. In that axial discrete wall steps are no longer present in the coupling elements, it is no longer required to first release an adjusted height position by exclusively axially lifting the pivot or the coupling element from the coupling receptacle and subsequently only then take a further position by a rotational movement, but alone already by a rotational movement of the pivot, the coupling element can then be automatically moved out of the coupling receptacle such that a type of helical twisting movement is effected already in detaching the coupling element from the coupling receptacle in this respect. Moreover, by such a shaping of the coupling element, location of the specific individual height position and thus an individual coupling receptacle is thus simplified and then gentle sliding of the coupling element into such a coupling receptacle is then also allowed. Thereby, undesirably strong abrupt forces between the coupling element and the coupling receptacle in coupling are also avoided.

The shape of the coupling element can be trapezoidally or bump-like configured with the ramp-like oblique surfaces formed on both sides in circumferential direction.

Preferably, it is provided that the coupling element is formed integrated on a bottom side of the coupling disk. By such an integral configuration, the number of members can be reduced and the positional accuracy of the coupling element can be permanently maintained. Thereby, the purposeful installation accurate in position in specific height positions can also be allowed. Undesired positional misalignments of the coupling element at the coupling disk, which optionally occur in a configuration between the coupling element and the coupling disk with separate members, can thereby be avoided. Thereby, the position of the coupling element relative to a coupling receptacle especially in radial direction to the rotational axis as well as in azimuthal direction thereto also stays always at the same location at the coupling disk such that precisely fitting plunging of the coupling element into a coupling receptacle in particular also remains always ensured.

Preferably, it is provided that the coupling element is formed on a first pedestal, which rises from a bottom side of the coupling disk facing the coupling receptacle or is formed raised to the bottom thereto. Thereby, a very exposed position of the coupling element is provided, which simplifies the coupling to the coupling receptacle. Moreover, this raised position of the coupling element on such a pedestal then again formed in raised manner, is advantageous to the effect that the pedestal can also mechanically couple to areas of the base part or the coupling receptacle and additional mechanic stabilizing mounts are then also provided in this context. The first pedestal is in particular formed integrated in the coupling disk.

Preferably, it is provided that the first pedestal extends further than the coupling element on both sides viewed in circumferential direction around the rotational axis. In particular, it is also configured to the effect that this first pedestal extends further on both sides of the coupling element in radial direction to the rotational axis and thus perpendicular to the rotational axis. In particular, the coupling element is formed centrally on this first pedestal. Thereby, secure and reliable coupling to the coupling receptacle results on the one hand, the coupling element is then virtually also bordered by the surface of the first pedestal in all sides on the other hand, such that this surface of the first pedestal circumferentially rests on the corresponding top side bounding the coupling receptacle in the coupling receptacle also in the coupled state of the coupling element to the coupling receptacle. The secure coupling on the one hand as well as the stable retention of a coupled state on the other hand are thereby supported.

Preferably, it is provided that a second pedestal is formed adjoining to a side of the first pedestal viewed in circumferential direction of the rotational axis, which rises to the bottom from the bottom side of the coupling disk and which has a lower height than the first pedestal viewed in the direction of the rotational axis. By the two pedestals directly adjoining to each other in azimuthal direction, which have different heights in axial direction, thus, a type of staircase profile is provided on the coupling disk. By such a configuration, the rotation of the pivot is simplified in a desired adjustment of the height position, since a stepped profile is then formed compared to the surface of the coupling disk, which has to overcome lower height steps such that a simpler and more user-friendly further rotation of the pivot is possible in interaction with a correspondingly stepped area in the base part since multiple surfaces in stepped areas of the coupling disk couple to multiple surfaces of a correspondingly stepped area in the base part and are shifted abutting on each other. The force distribution in this respect is then transferred to multiple or a larger overall surface area. Moreover, it is then also achieved by such a configuration that multiple surfaces of different pedestals of the coupling disk couple to multiple surfaces of a step profile then again disposed at different axial levels in the base part or abut on each other with a specifically adjusted height position such that the achieved desired individual height position is then also more securely retained and corresponding support forces are then transferred to multiple contact surfaces here too.

Preferably, it is provided that the second pedestal has a circumferential extent between 20° and 70°, in particular between 30° and 50°, viewed in circumferential direction around the rotational axis. Thereby, a second pedestal in the manner of a piece of cake is advantageously provided, by which the above mentioned advantages correspondingly act.

Preferably, it is provided that a third pedestal is formed on the bottom side of the coupling disk, wherein the third pedestal is offset to the first pedestal spaced in circumferential direction around the rotational axis, in particular by 180°.

Thereby, it is achieved in an advantageous implementation that a specific staircase profile with the two first pedestals is mirrored or redundantly designed at least in repetition of the second pedestal in a specific angular position around the rotational axis. Especially if a present staircase profile, to which the coupling disk couples for height position adjustment of the pivot, is also redundantly designed in the base part, a corresponding redundant coupling can here be achieved. The above mentioned advantages with respect to the mechanical stability and the more precise as well as easier to assemble adjustment are thereby again improved. Tilt forces on the pivot can thereby be avoided.

In an advantageous implementation, it is provided that the first pedestal has a circumferential extent between 20° and 70°, in particular between 30° and 50°, viewed in circumferential direction around the rotational axis. Here too, an individual indication of value of this azimuthal extension of the first pedestal is advantageous with regard to the fact that this pedestal is not too large on the one hand, but then comprises a corresponding surface on the other hand, which allows securely and circumferentially receiving the coupling element formed thereon to also allow a corresponding contact surface for abutting on a surface of the coupling receptacle or in the base part surrounding the coupling element on the other hand.

Preferably, it is provided that a fourth pedestal with a further coupling element is formed on the surface of the coupling disk, wherein the fourth pedestal is offset to the first pedestal spaced viewed in circumferential direction around the rotational axis, in particular by 180°. Here too, the advantages as they were mentioned with respect to the comparison of the second pedestal to the third pedestal apply. This redundant design of the actual coupling profile on the coupling disk with an again additional fourth pedestal with an again additional coupling element formed thereon also allows an even more stable and purposeful coupling and adjustment of the desired height position. The centered axial position of the pivot is in particular favored thereby.

Preferably, the height adjusting device is formed for adjusting the pivot in height direction in discrete height position levels. These discrete height levels are then preset by a specific staircase profile, which is in particular formed in the base part.

Preferably, it is provided that a staircase profile surrounding the rotational axis is formed on a surface facing the coupling disk of the coupling receptacle. Preferably, this staircase profile is configured in the manner of a spiral staircase. In particular, it is provided that this staircase profile with the continuously rising staircase steps extends around an angular segment around the rotational axis, which is less than 200°, in particular between 140° and 200°. In particular, this staircase profile extends in circumferential direction around the rotational axis in a circumferential extent of 180°. In an advantageous implementation, it is provided that such a staircase profile is redundantly formed and thus is configured once repeating in circumferential direction around the rotational axis. This means that the staircase profile extends around a circumferential extent of 180° around the rotational axis in a advantageous implementation and the further angular interval of then again 180° is occupied by a then duplicated corresponding staircase profile. Following the last staircase step of the staircase profile in circumferential direction, a first step of the then duplicated staircase profile is then directly adjoining formed. This means that the staircase profile specifies itself starting from a first step up to the last step with steps discretely located at higher level, wherein if the duplicated staircase profile begins, it is again begun on the first step and the steps then also again configure respectively with further steps discretely located in higher height positions. Between the last step of the staircase profile and the first step directly adjoining thereto of the staircase profile duplicated in this respect, therefore, there is a relatively high axial offset, which virtually represents the entire axial height, which is formed between a first step and a last step of the staircase profile.

Preferably, it is provided that recesses for locking a coupling element are formed on horizontal contact surfaces of the staircases of the staircase profile.

Advantageously, a recess is configured depression-like such that the bounding walls of this recess are correspondingly obliquely oriented like the oblique flanks of the coupling element. Thereby, the advantages with respect to the continuous and uniform sliding of the coupling element into the recess as well as of guiding the coupling element out of the recess are favored. Moreover, an advantageous precisely fitting fit of the coupling element in the recess is then also allowed. In particular, in the plunged state in the recess, the coupling element is form-fit disposed therein.

Advantageously, it is provided that in the coupled state between the coupling element and the coupling receptacle, the coupling element is locked in a recess of the coupling receptacle and a surface of the first pedestal adjoining to the coupling element rests on a surface of a horizontal contact surface of a staircase adjoining to the recess, wherein a surface of the second pedestal rests on a horizontal contact surface of a further staircase of the staircase profile directly adjoining to the staircase. A particularly solid fit secure in position of the pivot on the base part is then achieved and an individual height position in this respect is securely retained.

Preferably, it is provided that receptacles for an engaging tool are radially formed on a jacket wall of the coupling disk, by which the pivot is rotatable around the rotational axis. In this respect too, a very space saving solution easily accessible in terms of assembly is provided, to be able to move the pivot with respect to its rotation by an additional separate engaging tool.

In an advantageous implementation, the coupling receptacle, which is also formed as a depression, has a larger radius perpendicular to the rotational axis over a certain azimuthal angle and thus over a certain circumferential extent than over the remaining area of the circumferential extent. In particular, this circumferential extent with increased radius extends in an interval between 40° and 130°. In this radially expanded arc segment in the coupling receptacle, an additional lifting ramp of the height adjusting device can be formed, which is formed for interaction with a further radial coupling element formed radially protruding on the coupling disk.

In an implementation, it can be provided that the pivot is formed as a tubular member, wherein the coupling disk is formed spaced to the two ends of this tube part in axial direction, in particular is integrally formed on the jacket wall approximately centrally of the axial length of the tube part. In such a configuration, the base part comprises a channel-like receptacle, into which a partial area of this tube part of the pivot is inserted in plunging manner.

In an alternative implementation, it can be provided that the cylindrical elevation is integrally formed on the base part, which rises further to the top in axial direction than the staircase profile of the coupling receptacle in the base part. To this cylindrical elevation, a pivot differently formed in this respect can then be fitted. With such a configuration, the coupling disk is then disposed on the end side on a tube part of the pivot shortened in this respect and this cylindrical element in the base part plunges into the then present tube part of the pivot via the end, at which the coupling disk is formed on the pivot.

The height adjusting device is formed such that a change of the individual height position of the door has to be effected without dismounting the door from ii the pivot. This has also substantial advantages to the effect that the door can then be observed to the effect how it changes in the height position, in particular relative to the housing and/or to a further door of the household refrigeration apparatus. Thus, the door does not first have to be dismounted, the pivot adjusted relative to the base part by the height adjusting device and then the door again be mounted thereto to determine if the door then occupies the desired height position. But in this respect, it can then be directly recognized in adjusting the pivot, how the door changes in its height position in this respect. In this context, the door can then also be closed or opened in adjusting the height position of the pivot.

A further independent aspect of the invention relates to a household refrigeration apparatus with a housing and with a door separate thereto. The household refrigeration apparatus comprises at least one hinge, by which the door is pivotably disposed at the housing. The hinge comprises a pivot and a base part separate thereto, at which the pivot is rotatably supported around a rotational axis. Furthermore, the household refrigeration apparatus comprises a height adjusting device, which is formed at the hinge and by which the door is adjustable in the height position in height direction of the household refrigeration apparatus relative to the housing. Preferably, the pivot comprises an in particular annular coupling disk, which is a constituent of the height adjusting device. This coupling disk is coupled to a coupling receptacle formed in the base part, which is also a constituent of the height adjusting device.

Depending on a rotational position of the coupling disk around the rotational axis relative to the coupling receptacle, an individual height position of the pivot is adjusted. The height adjusting device comprises two pedestals adjoining to each other viewed in circumferential direction around the rotational axis, which are formed on a bottom side of the coupling disk and which extend downwards from a bottom side of the coupling disk. The pedestals couple to corresponding contact surfaces of staircases of a staircase profile with their plane surfaces oriented perpendicular to the rotational axis, which is a constituent of the height adjusting device and which is formed on the base part.

Implementations of the first aspect are to be regarded as advantageous implementations of the mentioned further independent aspect and vice versa.

With indications of “top”, “bottom”, “front”, “rear”, “horizontal”, “vertical”, “depth direction”, “width direction”, “height direction” etc., the positions and orientations given with intended use and intended arrangement of the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations or alone without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not comprise all of the features of an originally formulated independent claim.

Below, embodiments of the invention are explained in more detail based on schematic drawings. There show:

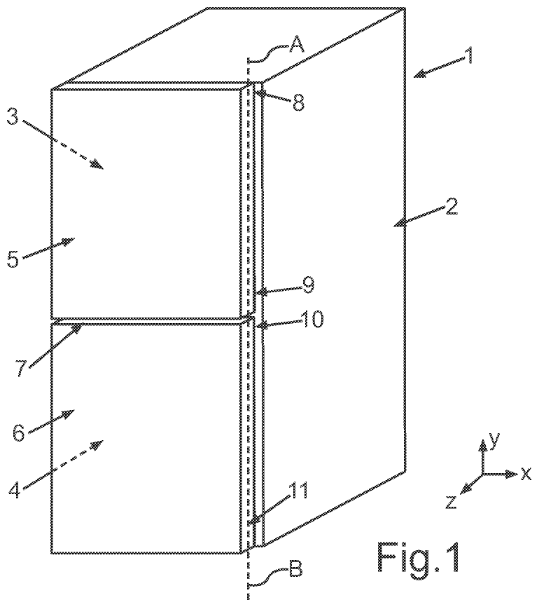

FIG. 1 a simplified perspective representation of an embodiment of a household refrigeration apparatus according to the invention;

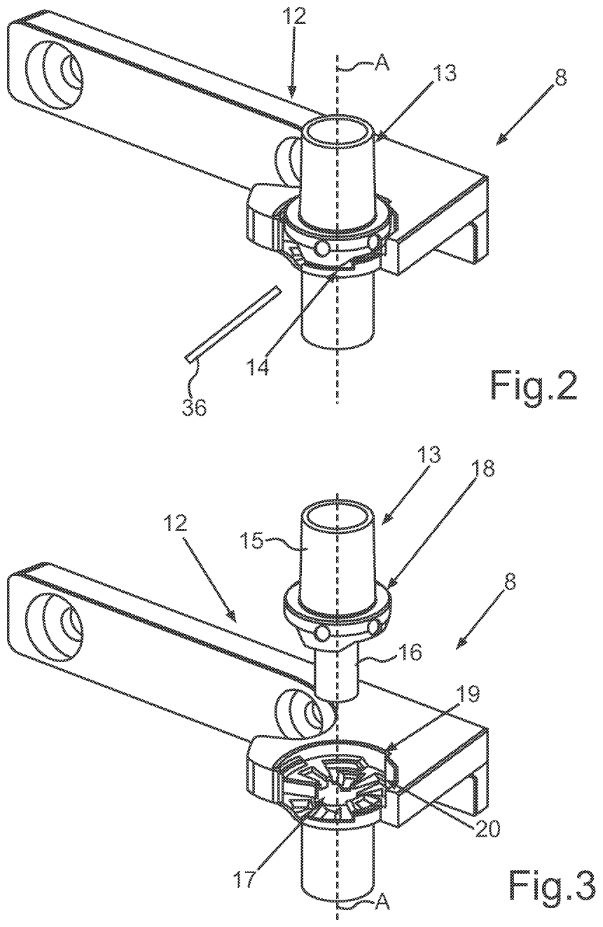

FIG. 2 a specific representation of a hinge with a height adjusting device;

FIG. 3 an exploded representation of the components according to FIG. 2;

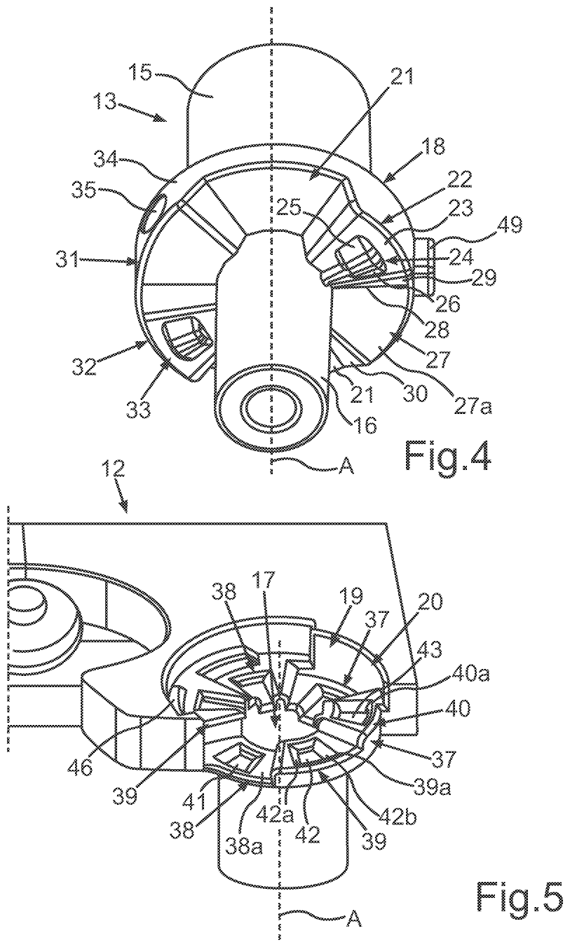

FIG. 4 a perspective representation of an embodiment of a pivot of the hinge with integrated components of a height adjusting device;

FIG. 5 a perspective representation of a partial area of a base part of the hinge with integrated further components of a height adjusting device;

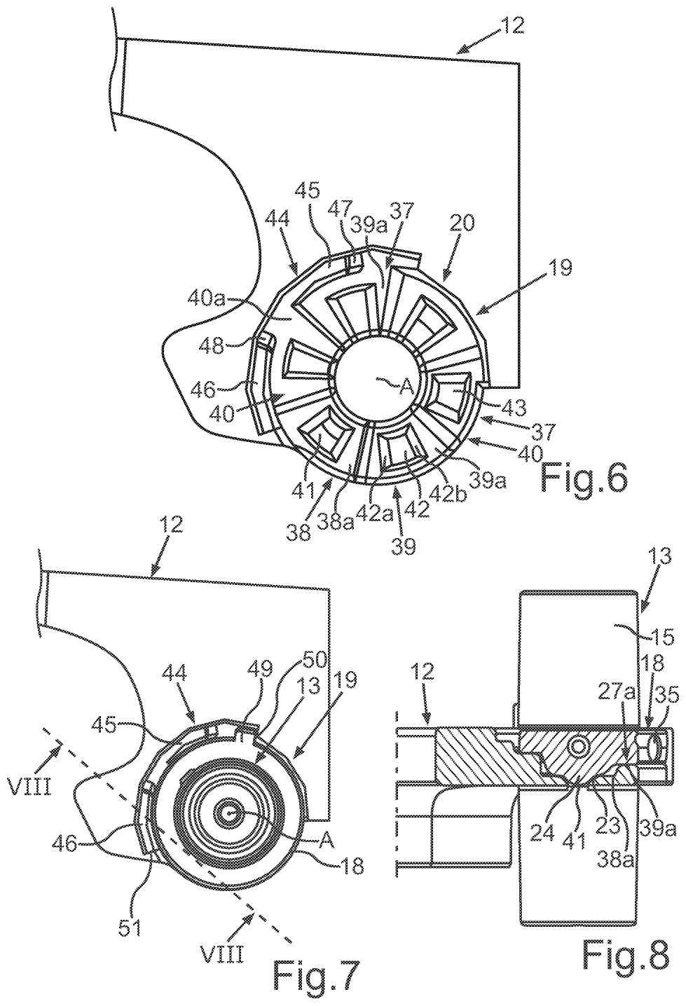

FIG. 6 a top view to the partial area according to FIG. 5;

FIG. 7 a top view to the representation according to FIG. 2 in the area of the pivot;

FIG. 8 a sectional representation of the configuration in FIG. 7;

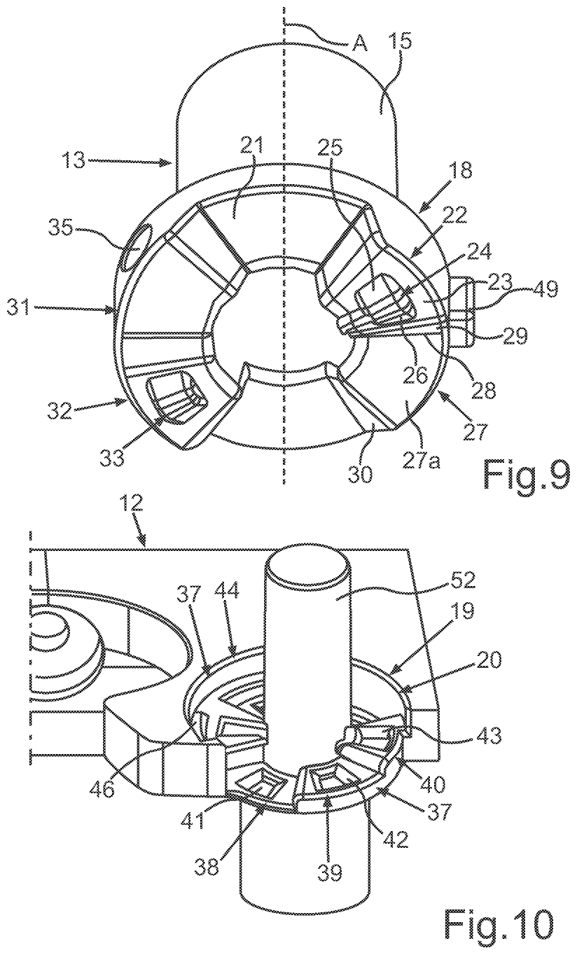

FIG. 9 a perspective representation of a further embodiment of a pivot with components of an integrated height adjusting device; and

FIG. 10 a perspective representation of a partial area of a base part of the hinge with a further embodiment in contrast to FIG. 5.

In the figures, identical or functionally identical elements are provided with the same reference characters.

In FIG. 1, a household refrigeration apparatus 1 is shown in a schematic representation, which can be a refrigerator or a freezer or a combined refrigerator-freezer. The household refrigeration apparatus 1, which is formed for storing and preserving food, comprises a housing 2, in which a first receiving space 3 for food and a second receiving space 4 for food separate thereto are formed in the shown embodiment. One of these two receiving spaces 3 and 4 can be a refrigerating compartment and the other one can be a freezing compartment. However, both receiving spaces 3, 4 can also be refrigerating compartments. Similarly, both receiving spaces 3, 4 can be freezing compartments.

The receiving space 3 is disposed above the further receiving space 4 in height direction (y-direction). However, the two receiving spaces 3, 4 can also be disposed next to each other.

Similarly, it is possible that one of the two receiving spaces 3, 4, for example the receiving space 3, is closed by two separate doors 5, 6, which are disposed next to each other in width direction (x-direction), and are disposed in the same or substantially the same height position to each other in height direction.

The door 5 is pivotably disposed at the housing 2 around a vertically oriented rotational axis A. Similarly, the door 6 is disposed pivotably at the housing 2 around a vertically oriented rotational axis B.

A horizontal gap 7 is formed between the two doors 5 and 6.

Moreover, the household refrigeration apparatus 1 comprises hinges 8 and 9, by which the door 5 is pivotably supported at the housing 2. Correspondingly, it is provided that hinges 10 and 11 are provided, by which the door 6 is pivotably disposed at the housing 2.

In FIG. 2, the hinge 8 is shown in an exemplary configuration. The hinge 8 comprises a base part 12, which is fixedly disposed at the housing. This base part 12 is also to be referred to as a bearing angle.

Moreover, the hinge 8 comprises an in particular cylindrical pivot 13, which represents an adjusting part of the hinge 8. The pivot 13 is rotatably disposed on the base part 12. The door 5 is rotationally fixedly connected to the pivot 13.

Moreover, the hinge 8 comprises a height adjusting device 14, which thus is formed integrated and thus integrally in the hinge 8. By means of the height adjusting device 14, the pivot 13 can be adjusted in its height position and thus in y-direction relative to the base part 12. Thereby, the door 5 is also correspondingly changed in its height position.

The height adjusting device 14 is formed in discrete steps for changing the height position.

The hinges 10 and 11 can also be correspondingly formed such that the door 6 is also adjustable in its height position.

In FIG. 2, the assembled state between the base part 12 and the pivot 13 is shown.

In FIG. 3, the hinge 8 is shown in an exploded view in a perspective partial representation, wherein the pivot 13 is here then removed from the base part 12, which is here only shown in certain areas. In the embodiment shown here, the pivot 13 is formed as a cylindrical part or pipe part. An upper pipe segment 15 is connected to a lower pipe segment 16. In particular, the pivot 13 is formed as an integral member. As is apparent in FIG. 3, the upper pipe segment 15 is formed with a larger radius than the lower pipe segment 16.

In the implementation shown here, the lower pipe segment 16 plunges into a channel-like or duct-like receptacle 17 of the base part 12 in the assembled state as is shown in FIG. 2.

As is moreover apparent in FIG. 3, the pivot 13 comprises an annular coupling disk 18, which is formed on the jacket wall of the pivot 13. This coupling disk 18 is a constituent of the height adjusting device 14. Here, the coupling disk 18 is preferably completely circumferentially formed.

The base part 12 comprises a depression 19. In the assembled state, the coupling disk 18 can plunge therein. A coupling receptacle 20 of the height adjusting device 14 is integrally formed in this depression or recess 19. This coupling receptacle 20 is also configured as an annular area, which surrounds the duct-like receptacle 17 on the circumferential side at the upper end. The recess 19 can also be a constituent of the coupling receptacle 20.

In FIG. 4, the integral pivot 13 according to a first embodiment is shown in an enlarged representation. As is apparent here, the coupling disk 18 comprises a first pedestal 22 on a bottom side 21, which faces the coupling receptacle 20 in the assembled state of the pivot 13. This first pedestal 22 is formed in the manner of a piece of cake and preferably formed in an angular interval with a circumferential extent between 20° and 70°, in particular between 30° and 50°, in circumferential direction around the axis A. As is apparent in FIG. 4, this first pedestal 22 extends raised to the bottom starting from the bottom side 21. This ii first pedestal 22 comprises a surface 23 spaced to the bottom side 21 in axial direction, which is preferably flatly formed and can also be regarded as the bottom side of the first pedestal 22 viewed in axial direction towards the bottom in this context. A coupling element 24 is formed on this surface 23 of the first pedestal 22. This coupling element 24 rises above this surface 23 and thus in axial direction towards the bottom in raised manner. This coupling element 24 is integrated in the first pedestal 22. In circumferential direction around the axis A, the coupling element 24 comprises ramp-like oblique flanks 25 and 26 on both sides. In the section in circumferential direction around the axis A, the coupling element 24 is trapezoidally or dome-like configured.

As is moreover apparent, the coupling element 24 is formed substantially centrally on this bottom side 23. The bottom side 23 extends both in azimuthal direction around the axis A and in radial direction and thus perpendicular to the axis A respectively beyond the dimensions of the coupling element 24.

Viewed in circumferential direction around the axis A, the height adjusting device 14 comprises a second pedestal 27 besides the already mentioned first pedestal 22 and the coupling element 24, which immediately adjoins to an edge side 28 of the first pedestal 22.

This second pedestal 27 also rises from the bottom side 21 towards the bottom, but has a lower axial height in axial direction than the first pedestal 22, respectively viewed starting from the bottom side 21.

The second pedestal 27 extends in a circumferential extent preferably between 20° and 70°, in particular between 30° and 50°, in circumferential direction around the axis A.

The transitional flank 29 of the first pedestal 22, which joins to the second pedestal 27, is preferably also formed as an oblique flank.

In particular, a terminating flank 30, which represents the end of the second pedestal 27 and faces away from the first pedestal 22, is also formed as an oblique flank, which then again joins to the bottom side 21.

In an advantageous implementation, the second pedestal 27 is also a constituent of the height adjusting device 14.

In the shown embodiment, it is provided that the first pedestal 22, the coupling element 24 and the second pedestal 27 are redundantly designed and duplicated in this respect. Here, it is in particular provided that the respectively mentioned partial elements in their duplicated design are offset to each other by 180° in circumferential direction around the axis A. This means, that a third pedestal 31 is here provided, which is offset to the second pedestal 27 by 180°, but otherwise is correspondingly formed. Moreover, a fourth pedestal 32 is provided, which corresponds to the first pedestal 22 and is in particular identically formed with respect to the shaping and height configuration. This fourth pedestal 32 is also disposed offset to the first pedestal 22 by 180°. The fourth pedestal 32 comprises a further coupling element 33, which is formed identical to the first coupling element 24 in shaping and position and disposed offset by 180° to the first coupling element 24.

The surface 23, the surface 27a are flatly formed and thus the entire surfaces are each disposed in individual axial position. As is moreover apparent in FIG. 2 to 4, the coupling disk 18 comprises a plurality of separate receptacles 35 on its jacket wall 34, which are formed as insertion holes. Thereby, it can be engaged by an auxiliary tool 36 (FIG. 2) and a rotational movement of the pivot 13 around the rotational axis A relative to the base part 12 can be effected.

In FIG. 5, the partial area of the base part 12, as it is also apparent in FIG. 3, is shown in an enlarged representation. As is apparent here, a staircase profile 37 of the coupling receptacle 20 surrounding the rotational axis at least in certain areas is integrally formed on a surface of the coupling receptacle 20 facing the coupling disk 18. This staircase profile 37 comprises a first step or first staircase 38 and a further staircase 39 directly adjoining thereto viewed in circumferential direction of the axis A, which is a staircase located at higher level in axial direction. A third staircase 40 is formed directly adjoining to the second staircase 39 again viewed in circumferential direction of the axis A, which is again located at higher level than the second staircase 39.

In the shown embodiment, the staircase profile 37 extends around a circumferential extent of 180° around the axis A. Here, it is provided that this staircase profile 37 too is implicitly and thus redundantly designed. This means that the three staircases 38, 39 and 40 are again formed, wherein subsequent to the uppermost or highest staircase 40, a deepest or first staircase 37 is then again formed directly adjoining. Viewed in circumferential direction around the axis A, a second staircase 38 then again follows and a highest third staircase 39 again adjoining thereto, which then again directly adjoins to the first, deepest staircase 38 of the primary staircase profile 37.

The staircases 38, 39 and 40 each comprise contact surfaces 38a, 39a and 40a, which are preferably each flat and horizontal (oriented perpendicular to the axis A). Receiving depressions 41, 42 and 43 are respectively formed in these contact surfaces 38a, 39a and 40a. A coupling element, in particular the coupling element 24, plunges into these receiving depressions 41 to 43. If a first, lowest height position of the pivot 13 to the base part 12 is adjusted, thus, the coupling element 24 is locked in the receiving depression 41. If a second discrete height position is adjusted, which is higher than this first height position, thus, the coupling element 24 is locked in the receiving depression 42. Moreover, if the coupling element 24 is locked in the receiving depression 43, the third, discrete and highest height position of the pivot 13 relative to the base part 12 is adjusted. The door 5 is then also correspondingly adjustable in the three different height positions here to be exemplarily understood.

The further coupling element 33 then respectively correspondingly and complementarily plunges into the respectively other receiving depressions of the staircases 38 to 40 of the redundantly formed staircase or the staircase profile 37.

Advantageously, it is provided that bounding walls of a receiving depression 41, 42, 43 viewed in circumferential direction around the axis A are obliquely and/or rounded formed. This is exemplarily shown by the bounding walls 42a and 42b in FIG. 5 with respect to the receiving depression 42. Thereby, a continuous and simpler sliding in as well as sliding out of the coupling element 24 from this receiving depression 42 is allowed. In an advantageous implementation, it can be provided that the oblique flanks 25 and 26 are adapted to the shaping of the bounding walls 42a and 42b such that a form-fit abutment over the entire surface area of these mentioned walls is substantially achieved in this respect.

As is moreover apparent, the depression 19 is formed with such an axial depth that the coupling disk 18 is disposed completely recessed in the recess 19 in the assembled state as it is shown in FIG. 2.

In FIG. 6, the base part 12 is shown in the area of the coupling receptacle 20 in a top view. A staircase profile 37 with its three staircases 38, 39 and 40 to be exemplarily understood here extends around a circumferential extent of 180°. Here, the staircases 38, 39 and 40 form a discretely rising staircase profile and thus represent a section of a spiral staircase.

As is apparent in FIG. 6 in the top view, the recess 19 is formed with a larger radius over a partial segment in circumferential direction around the axis A than in a further other area different thereto. This area 44 with the larger radius extends around a circumferential extent preferably between 50° and 120°. As is moreover apparent in FIG. 6, an integrated web 45 as well as a further integrated web 46 are formed in this radially wider area, which each comprise oblique flanks 47 and 48. Therein, the web 45 is formed on a top side or contact surface 39a on a second staircase of the implied staircase profile 37. The further web 46 spaced thereto in circumferential direction is formed on the contact surface 40a of the staircase 40. The webs 45 and 46 preferably extend in radial direction only over the dimensions, over which the radially expanded area 44 radially extends beyond the other area of the recess 19.

In this respect, it is provided in an advantageous implementation that the pivot 13, as it is shown in FIG. 4, comprises a radial coupling element 49, which can then couple to these webs 45 and 46.

In FIG. 7, a top view to the representation in FIG. 6 is shown, wherein the pivot 13 according to FIG. 4 is here inserted in the recess 19 such that the coupling disk 18 is received in the recess 19 and the height adjusting device 14 is coupled. This means that the pedestals 22, 27, 31 and 32 as well as the coupling elements 24 and 33 are coupled to the staircase profiles 37.

By this radial coupling element 49, a stop can also be formed such that the maximum capability of rotation of the pivot 13 around the rotational axis A can also be limited by the circumferential extent of the radially expanded area 44. In FIG. 7, it is shown how this radial coupling element 49 abuts on a first stop wall 50 of the radially expanded area 44. A further stop wall 51 of this radially expanded area 44 is shown opposing.

In FIG. 8, the configuration according to FIG. 7 is shown in a sectional representation along the sectional line VIII-VIII in FIG. 7. Here, it is apparent how the coupling element 24 is locked in the receiving depression 41. Moreover, it is also apparent that the top side 23 of the first pedestal 22 rests on the contact surface 38a, and how the top side 27a of the second pedestal 27 rest on the next higher step 39 and there on the contact surface 39a.

In FIG. 9, a further embodiment of a pivot 13 is shown. In contrast to the configuration of FIG. 4, here, the lower pipe segment 16 is not present. Thus, the coupling disk 18 here represents the lower termination of the pivot 13 in axial direction.

In FIG. 10, the base part 12 is partially shown in a further embodiment in a perspective representation. In contrast to the implementation according to FIG. 5 and FIG. 6, here, it is provided that a cylindrical element 53 in particular protruding from the recess 19 is integrally formed, to which the pivot 13 according to FIG. 9 can then be fitted. In this context with regard to the coupling of the pivot 13 to the base part 12, an inverse configuration compared to the examples according to FIG. 3 to FIG. 8 is shown.

In the example in FIG. 9 and FIG. 10, the remaining configuration of the height adjusting device 14 is corresponding as in the embodiment according to FIG. 2 to FIG. 8.

### LIST OF REFERENCE CHARACTERS

1 Household refrigeration apparatus

2 housing

3 receiving space

4 receiving space

5 door

6 door

7 gap

8 hinge

9 hinge

10 hinge

11 hinge

12 base part

13 pivot

14 height adjusting device

15 pipe segment

16 pipe segment

17 receptacle

18 coupling disk

19 depression

20 coupling receptacle

21 bottom side

22 first pedestal

23 surface

24 coupling element

25 oblique flank

26 oblique flank

27 second pedestal

27a top side

28 side

29 transitional flank

30 terminating flank

31 pedestal

32 pedestal

33 coupling element

34 jacket wall

35 receptacle

36 auxiliary tool

37 staircase profile

38 staircase

38a contact surface

39 staircase

39a contact surface

40 staircase

40a contact surface

41 receiving depression

42 receiving depression

42a bounding wall

42b bounding wall

43 receiving depression

44 area

45 web

46 web

47 oblique flank

48 oblique flank

49 coupling element

50 stop wall

51 stop wall

52 cylindrical element

A rotational axis

B rotational axis

1-14. (canceled)

15. A household refrigeration apparatus, comprising:
a housing, a door, and a hinge pivotably mounting said door to said housing;
said hinge having a pivot and a base part separate from said pivot and rotatably supporting said pivot about a rotational axis;
a height adjusting device formed at said hinge and configured for adjusting a height position of said door in a height direction relative to said housing, said height adjusting device having an annular coupling disk at said pivot and a coupling receptacle at said base part, wherein an individual height position of said pivot is adjusted depending on a rotational position of said coupling disk about the rotational axis relative to said coupling receptacle;
said coupling disk having a coupling element formed with ramp-shaped oblique flanks on both sides viewed in circumferential direction around the rotational axis, by which said coupling element plunges into said coupling receptacle in a direction of the rotational axis.

16. The household refrigeration apparatus according to claim 15, wherein said coupling element is integrally formed on a bottom side of said coupling disk.

17. The household refrigeration apparatus according to claim 15, wherein said coupling element is formed with a first pedestal, which rises from a bottom side of said coupling disk facing said coupling receptacle.

18. The household refrigeration apparatus according to claim 17, wherein said first pedestal extends farther than said coupling element on both sides in circumferential direction around the rotational axis.

19. The household refrigeration apparatus according to claim 17, further comprising a second pedestal formed adjoining to a side of said first pedestal viewed in circumferential direction of the rotational axis, said second pedestal rising from a bottom side of said coupling disk and having a lower height than said first pedestal viewed in the direction of the rotational axis.

20. The household refrigeration apparatus according to claim 19, wherein said second pedestal has a circumferential extent between 20° and 70°, in circumferential direction around the rotational axis.

21. The household refrigeration apparatus according to claim 20, wherein the circumferential extent of said second pedestal lies between 30° and 50°.

22. The household refrigeration apparatus according to claim 19, further comprising a third pedestal formed on the bottom side of said coupling disk, said third pedestal being offset from said second pedestal spaced in circumferential direction around the rotational axis.

23. The household refrigeration apparatus according to claim 22, wherein said third pedestal is offset from said second pedestal in circumferential direction by 180°.

24. The household refrigeration apparatus according to claim 17, wherein said first pedestal has a circumferential extent between 20° and 70° in circumferential direction around the rotational axis.

25. The household refrigeration apparatus according to claim 24, wherein circumferential extent is between 30° and 50°

26. The household refrigeration apparatus according to claim 22, further comprising a fourth pedestal with a further coupling element formed on the bottom side of said coupling disk, said fourth pedestal being offset with a spacing from said first pedestal in circumferential direction around the rotational axis.

27. The household refrigeration apparatus according to claim 26, wherein said fourth pedestal is offset in the circumferential direction from said first pedestal by 180°.

28. The household refrigeration apparatus according to claim 15, wherein said coupling receptacle is formed with a staircase profile surrounding the rotational axis on a surface of said coupling receptacle facing said coupling disk.

29. The household refrigeration apparatus according to claim 28, wherein said staircase profile is formed with staircases with horizontal contact surfaces and said horizontal contact surfaces are formed with recesses for locking said coupling element.

30. The household refrigeration apparatus according to claim 28, wherein said staircase profile continuously rising with staircases is formed only partially surrounding the rotational axis.

31. The household refrigeration apparatus according to claim 30, wherein said staircase profile is formed in duplicate in the circumferential direction around the rotational axis.

32. The household refrigeration apparatus according to claim 28, wherein, in a coupled state between said coupling element and said coupling receptacle, said coupling element is locked in a receiving depression, and a surface of a first pedestal adjoining said coupling element rests on a surface of a horizontal contact surface of a first staircase adjoining said receiving depression, and a surface of a second pedestal rests on a horizontal contact surface of a second staircase directly adjoining said first staircase.

33. The household refrigeration apparatus according to claim 15, wherein a jacket wall of said coupling disk is formed with receptacles for an engaging tool, for effecting a rotation of said pivot about the rotational axis.
